(19) United States
(12) Patent Application Publication
(10) Pub. No.: US 2021/0192358 A1
(43) Pub. Date: Jun. 24, 2021

(54) GRAPH NEURAL NETWORK SYSTEMS FOR BEHAVIOR PREDICTION AND REINFORCEMENT LEARNING IN MULTPLE AGENT ENVIRONMENTS

(71) Applicant: DeepMind Technologies Limited, London (GB)

(72) Inventors: Hasuk Song, London (GB); Andrea Tacchetti, London (GB); Peter William Battaglia, London (GB); Vinicius Zambaldi, London (GB)

(21) Appl. No.: 17/054,632

(22) PCT Filed: May 20, 2019
(86) PCT No.: PCT/EP2019/062943

§ 371 Date: Nov. 11, 2020

Related U.S. Application Data
(60) Provisional application No. 62/673,812, filed on May 18, 2018.

(51) Int. Cl. G06N 3/08; G06N 3/04

(52) U.S. Cl. CPC G06N 3/088; G06N 3/0445; G06N 3/0454

(57) ABSTRACT

Methods, systems, and apparatus, including computer programs encoded on a computer storage medium, for predicting the actions of, or influences on, agents in environments with multiple agents, in particular for reinforcement learning. In one aspect, a relational forward model (RFM) system receives agent data representing agent actions for each of multiple agents and implements: an encoder graph neural network subsystem to process the agent data as graph data to provide encoded graph data, a recurrent graph neural network subsystem to process the encoded graph data to provide processed graph data, a decoder graph neural network subsystem to decode the processed graph data to provide decoded graph data and an output to provide representation data for node and/or edge attributes of the decoded graph data relating to a predicted action of one or more of the agents. A reinforcement learning system includes the RFM system.

### BACKGROUND

This specification relates to neural networks for predicting the actions of, or influences on, agents in environments with multiple agents, in particular for reinforcement learning.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks represent graph structures comprising nodes connected by edges; the graphs may be multigraphs in which nodes may be connected by multiple edges. The nodes and edges may have associated node features and edge features; these may be updated using node functions and edge functions, which may be implemented by neural networks.

### SUMMARY

This specification describes neural network systems and methods implemented as computer programs on one or more computers in one or more locations for processing data representing the behaviors of multiple agents, for predicting actions of the agents or for determining influences on the actions of the agents. The agents may be robots on a factory floor or autonomous or semi-autonomous vehicles. The described neural network systems may be used in reinforcement learning, for example to improve performance by anticipating the actions of other agents, or for learning cooperative behavior.

Thus in one aspect a relational forward model (RFM) neural network system for predicting or explaining the actions of multiple agents in a shared environment comprises an input to receive agent data representing agent actions for each of multiple agents, and one or more processors. The one or more processors are configured to implement an encoder graph neural network subsystem to process the agent data as (in conjunction with) graph data to provide encoded graph data. The graph data may comprise data representing at least nodes and edges of a graph; the edges may be directed or undirected. Each of the agents may be represented by a node. Non-agent entities in the environment may also each be represented by a node. The nodes have node attributes, for example for determining the actions of each agent. The nodes may each have the set of same attributes. The graph data provided to the encoder may lack edge attributes. The edges may connect the agents to each other and to the non-agent entities. The encoded graph data may comprise node attributes and edge attributes representing an updated version of the graph data.

The one or more processors may further be configured to implement a processing, in particular recurrent graph neural network subsystem. The recurrent/processing graph neural network subsystem may comprise a recurrent neural network to process the encoded graph data and provide processed graph data comprising an updated version of the node attributes and edge attributes of the encoded graph data. The one or more processors may further be configured to implement a decoder graph neural network subsystem to decode the processed graph data and provide decoded graph data comprising an updated version of the node attributes and edge attributes of the processed graph data. The system may have a system output to provide representation data comprising a representation of one or both of the node attributes and edge attributes of the decoded graph data for one or more, for example all of the agents. The representation may relate to a predicted or explained action of one or more of the agents e.g. derived respectively from the node attributes or edge attributes of the decoded graph data.

In some implementations the actions may comprise movements of the agents. Thus the agent data captured by the system may comprise agent position and motion data for each of the agents. The node attributes may then include attributes for the position and motion of each agent. In some implementations each of the agents may be connected to each of the other agents by an edge, and each of the non-agent entities may be connected to each of the agents by an edge. However in implementations non-agent entities, for example static entities, are not be connected by edges.

In some implementations the system output comprises one or more output neural network layers, for example a multilayer perceptron (MLP). The node attributes may be represented as a vector. The one or more output neural network layers may combine the node attributes for a node in the decoded graph data in order to output the representation data. The representation derived from a node may comprise a predicted action of the agent represented by the node. The representation data may define a spatial map, such as a heat map, of data derived from the node attributes of one or more nodes representing one or more of the agents. In such a map the data derived from the node attributes may be represented at a position of the respective node. For example where the actions may comprise movements of the agents the map may represent the probability of each of the agents represented being in a position.

In some implementations the representation data comprises a representation of the edge attributes of the decoded graph data for the edges connecting to one or more of the nodes. The representation of the edge attributes for an edge may be determined from a combination of the edge attributes for the edge. For example the edge attributes may be represented as a vector and the combination of edge attributes for an edge may be a vector norm such as a p-norm, where p is an integer.

In implementations the edges are directed (although nodes may be connected by edges in two opposite directions). Thus an edge may connect from an origin node to an end node, for example from an agent or non-agent entity node to an agent node. The representation of the edge e.g. vector norm may represent the importance to or influence of the origin node on the agent node to which it connects.

The edge representation data may define a spatial map such as a heat map. In the spatial map the representation of the edge attributes for an edge, for example a vector norm of the attributes, may be located at an origin node position for the edge. Such a spatial map may be defined on a per-agent basis, that is there may be one map for each agent considered.

The hypothesis is that the representation of the edge, for example the vector norm, represents the importance of the edge. Thus the edge attributes of the decoded graph may encode information which can be used to explain the behaviour of an agent, for example by indicating which nodes influenced an action or by identifying which other node(s) are most influential to a particular agent, for example by ranking the other nodes. Changes in this explanatory information may be tracked over time.

A neural network system as described above may be trained by supervised training, for example based on observations of the behaviour of the multiple agents in the shared environment.

In a neural network system as described above comprising one or more of the encoder, processing, and decoder graph neural network subsystems may be configured to implement graph network processing as follows: For each of the edges, process the edge features using an edge neural network to determine output edge features. For each of the nodes, aggregate the output edge features for edges connecting to the node to determine aggregated edge features for the node. For each of the nodes, process the aggregated edge features and the node features using a node neural network to determine output node features. This procedure may be performed once or multiple times iteratively. Processing the edge features may comprises, for each edge, providing the edge features and node features for the nodes connected by the edge to the edge neural network to determine the output edge features.

One or more of the encoder, processing, and decoder graph neural network subsystems may be further configured to determine a global feature vector using a global feature neural network. The global feature vector may represent the output edge features and the output node features. Where the encoder graph neural network subsystem determines a global feature vector the subsequent processing and decoder graph neural network subsystems may also operate on the global feature vector. A graph neural network subsystem, such as the processing (recurrent) graph neural network subsystem, may comprise a recurrent graph network. Then one or more of the edge neural network, the node neural network, and a global feature neural network (described below) may comprise a recurrent neural network, for example a GRU (Gated Recurrent Unit) neural network.

In some implementations the system may be included in a reinforcement learning system. The reinforcement learning system may be configured to select actions to be performed by one of the agents interacting with the shared environment. The reinforcement learning system may comprise an input to obtain state data representing a state of the shared environment, and reward data representing a reward received resulting from the agent performing the action. The state data may be derived, for example, by capturing one or more observations, such as images, from the environment and processing these using an observation processing neural network such as a convolutional neural network. The reinforcement learning system may further comprise an action selection policy neural network to process the state data and reward data to select the actions. The action selection policy neural network may be configured to receive and process the representation data to select the actions.

The observations may also be used for training the system for predicting/explaining the actions of the agents. For example the observation processing neural network or another neural network may be configured to identify the actions of the agents in the environment. The observation processing neural network or another neural network may additionally or alternatively be configured to identify the agents and/or the non-agent entities, for example for adapting the graph according to the entities present.

The reinforcement learning system may, in general, be of any type. For example it may be a policy-based system such as an Advantage Actor Critic, A2C or A3C, system (e.g. Mnih et al. 2016), which directly parameterizes a policy and value function. Alternatively it may be a Q-learning system, such as a Deep Q-learning Network (DQN) system or Double-DQN system, in which the output approximates an action-value function, and optionally a value of a state, for determining an action. In another alternative it may be a distributed reinforcement learning system such as IMPALA (Importance-Weighted Actor-Learner), Espholt et al., arXiv:1802.01561. In a continuous control setting it may directly output an action e.g. a torque or acceleration value, for example using the DDPG (Deep Deterministic Policy Gradients) technique (arXiv 1509.02971) or a variant thereof.

In some implementations the reinforcement learning system may be configured to train the neural network system for predicting or explaining the actions of the agents from observations of the shared environment during training of the reinforcement learning system. Thus the two systems may be trained jointly. The neural network system for predicting or explaining the actions of the agents may be private to the reinforcement learning system, that is it need not rely for training on data not available to the reinforcement learning system. In some implementations the two systems may be co-located in one of the agents, and may learn alongside one another.

Optionally the graph network processing may include a self-referencing function, implemented by a neural network. For example a node update may be dependent upon the initial features of the node. Such processing may be advantages in facilitating the agent in predicting its own actions, which may enhance the information upon which the action selections are based. Optionally the neural network system for predicting or explaining the actions of the agents may be rolled out for multiple time steps to provide additional information for the reinforcement learning system. Thus the system may be used for imagination-based planning (Weber et al., arXiv:1707.06203).

There is also described a method of predicting or explaining the actions of multiple agents in a shared environment. The method may comprise receiving agent data representing actions for each of multiple agents. The method may further comprise processing the agent data in conjunction with graph data to provide encoded graph data. The graph data may comprise data representing at least nodes and edges of a graph, wherein each of the agents is represented by a node, wherein non-agent entities in the environment are each represented by a node, wherein the nodes have node attributes for determining the actions of each agent, wherein the edges connect the agents to each other and to the non-agent entities, and wherein the encoded graph data comprises node attributes and edge attributes representing an updated version of the graph data. The method may further comprise processing the encoded graph data using a recurrent graph neural network to provide processed graph data comprising an updated version of the node attributes and edge attributes of the encoded graph data. The method may further comprise decoding the processed graph data to provide decoded graph data comprising an updated version of the node attributes and edge attributes of the processed graph data. The method may further comprise outputting a representation of one or both of the node attributes and edge attributes of the decoded graph data for one or more of the agents, wherein the representation relates to a predicted or explained behaviour of the agent.

The behaviours may comprise actions of the agents. Outputting the representation may comprise processing the node attributes for a node of the decoded graph data to determine a predicted action of the agent represented by the node.

The method may be used for explaining the actions of the agents. Outputting the representation may then comprise processing the edge attributes of an edge of the decoded graph data connecting an influencing (origin) node, which may be an agent or non-agent node, to an agent node to determine data representing the importance of the influencing node to the agent node.

The method may be used in reinforcement learning. For example the reinforcement learning may learn a policy for selecting an action to be performed by an agent dependent upon the state of an environment shared by multiple agents. The reinforcement learning method may comprise predicting behaviours of the agents in the environment using the described method and then using the predicted behaviours to learn the policy.

In general implementations of the described systems and methods may be employed with real or simulated agents and environments. The environment may be a real-world environment and the agent may be a mechanical agent such as a robot interacting with the real-world environment. In some other implementations the agents may comprise control devices operating in a manufacturing or service facility and working together to control aspects of the facility, for example the operating temperature of a server farm. Other examples are described later.

The subject matter described in this specification can be implemented in particular embodiments so as to realize one or more of the following advantages.

Some implementations of the described neural network systems are able to characterize the behavior of multiple autonomous agents, such as robots in a factory or autonomous or semi-autonomous vehicles. This information can then be used to train an agent to accomplish a task more effectively or more efficiently. For example an agent such as a mechanical agent may be trained to accomplish a task with improved performance, and/or using less data and processing resources. More particularly, training is faster and uses less data and computational resources than some other techniques, and the described systems can both predict actions and influences which enables them to learn in situations where other techniques could find it difficult, thus facilitating better performance.

The described neural network systems can also be used by an agent so that the agent may cooperate with other agents to perform a task. The other agents may or may not be of the same type; for example they may be human-controlled or computer-controlled or they may originate from different manufacturers. One example of such cooperative behavior is the control of multiple robots on a factory or warehouse floor; equipping such a robot with a neural network system of the type described herein can facilitate improved robot control because the behavior of the other robots can be taken into account. In another example an autonomous or semi-autonomous vehicle can use neural network system of the type described to predict the behavior of other road users or pedestrians and hence improve safety.

Significantly, because the described systems for predicting/explaining the actions of multiple agents require less experience to learn they can achieve good results when trained jointly with a reinforcement learning system, even whilst the other agents are still learning and their behavior is changing.

In some other applications the described neural network systems can provide information relating to the motivation or intention of an agent. That is, information derived from the edges of the processed graph can be used to determine why an agent acted in the way it did, or how it might act. This can give insight into the way an autonomous agent under control of a machine learning system is acting. This information can be useful for regulatory and other purposes since, if the motivations for the actions of an autonomous system can be discerned it is easier to trust such a system.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

### BRIEF DESCRIPTION OF THE DRAWINGS

FIG. 1 shows an example neural network system for predicting or explaining the actions of multiple agents in a shared physical system environment.

FIGS. 2a and 2b show a graph neural network subsystem, and operation of the graph neural network subsystem.

FIG. 3 shows details of a graph processing neural network system for predicting or explaining the actions of multiple agents in a shared physical system environment

FIG. 4 shows a process for using the graph processing neural network system of FIG. 3 to provide representation data predicting an agent action.

FIGS. 5a and 5b show shows locations of agents on a grid (upper) and (lower), respectively, an example heat map of action predictions and an example heat map of agent-entity importance relationships.

FIG. 6 shows an agent including a reinforcement learning system incorporating the graph processing neural network system of FIG. 3.

Like reference numbers and designations in the various drawings indicate like elements.

### DETAILED DESCRIPTION

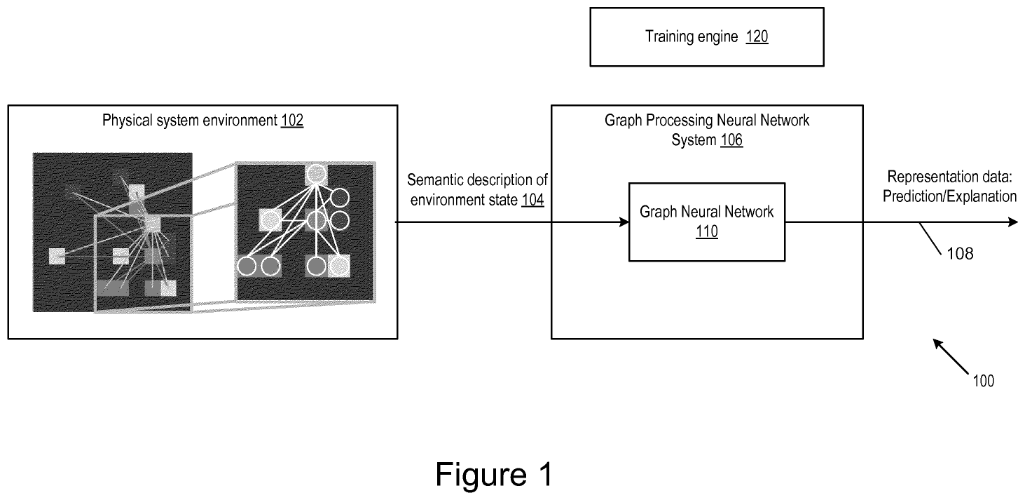

FIG. 1 shows an example neural network system 100 for predicting or explaining the actions of multiple agents in a shared physical system environment 102. The neural network system 100 is an example of a system implemented as computer programs on one or more computers in one or more locations, in which the systems, components, and techniques described below can be implemented.

The agents may include mechanical agents such as robots or vehicles in a real or simulated environment and the system may predict or explain their behavior, e.g. for safety or control purposes. For example the neural network system 100 may be used in a robot or vehicle control system to control the behavior of the robot/vehicle in accordance with a prediction or explanation of the behavior of one or more of the other agents, which may be other robots/vehicles and/or people. The control system may comprise a reinforcement learning system. An explanation of the behavior of a particular agent may comprise data defining an importance or influence of one or more other agent or non-agent entities in the environment on the particular agent. This data may similarly be used by a control system to control an agent in response to an explanation of the behavior of one or more other agents e.g. other robots/vehicles or people. Further examples are given later.

Non-agent entities in the environment may include objects to be collected, manipulated, moved and/or dropped, static objects or entities such as obstacles or markers, entities defining permitted or preferred movement or locations e.g. routes, lanes, passageways, thoroughfares, parking spaces (which may be occupied or unoccupied) and the like, entities providing instructions or control commands, e.g. signage, and so forth.

The neural network system 100 receives a semantic description of the state of the environment 104, which is formatted as a graph as explained below, and processes the data to provide an output comprising representation data for predicting and/or explaining the behavior of the agents in the environment. The neural network system 100 comprises a graph processing neural network system 106 including one or more graph neural network blocks 110 which process the input graph to provide data for an output 108, in the form of an output graph from which the representation data can be derived to predict and/or explain the behavior of the agents. In some implementations, e.g. reinforcement learning applications, the neural network system 100 may include a training engine 120 to train the graph processing neural network system 106, as described later. For example in a reinforcement learning application an agent may include the graph processing neural network system 106 to augment observations of the environment with predictions of the behavior of the other agents.

The semantic description of the state of the environment may be a description in which data about the environment is explicit rather than inferred e.g. from observations. The semantic description of the state of the environment may include agent data and data relating to non-agent e.g. static entities. This data may include, for each agent and non-agent entity and where applicable, one or more of: position, movement e.g. a velocity vector, type (e.g. one-hot encoded), state or configuration, and (for agents) the last action taken by the agent. The semantic description of the state of the environment may also include global information such as a score or reward associated with the environment such as a score in a game or a score or reward associated with completion of one or more tasks.

The semantic description of the state of the environment is compiled into a graph data representing the state of the environment as an input graph Gᵢₙ^{t}, in particular a directed graph. In the input graph each of the agent and non-agent entities may be represented by a node and edges may connect each agent to each other agent and to each non-agent entity (non-agent entities need not be connected). The semantic description of the state of the environment may be used to provide attributes for nodes of the input graph. The input graph may have no attributes for the edges; an agent cooperative/non-cooperative (teammate) attribute may be indicated in an edge attribute of the input graph. The output graph has edge attributes; each of these provides a representation of the effect a sender node has on a receiver node.

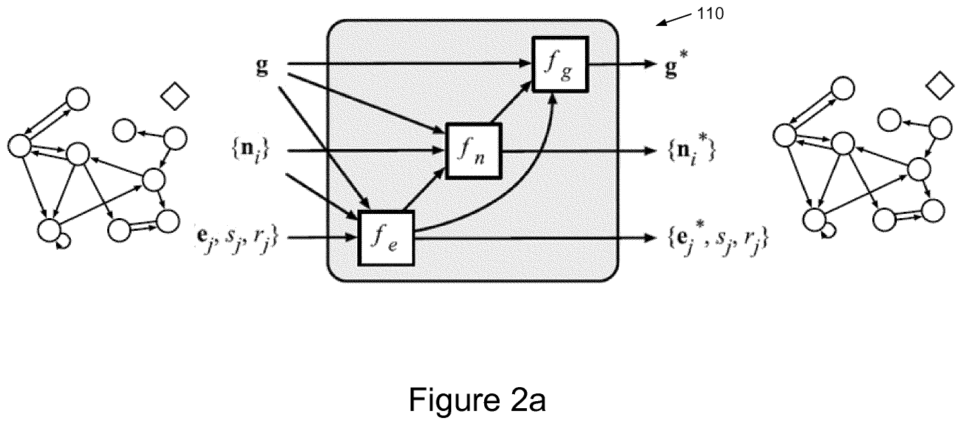

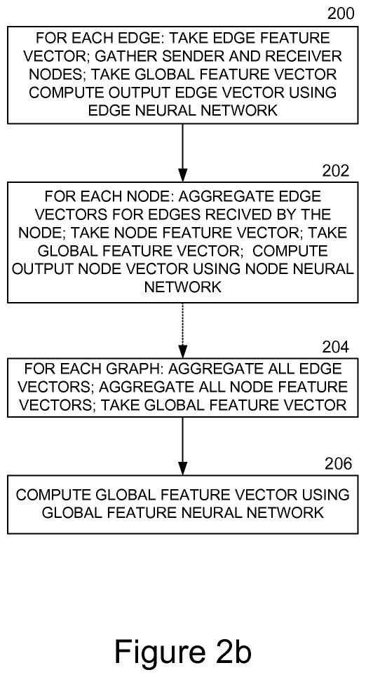

FIG. 2a shows a graph neural network subsystem 110. This subsystem accepts an input directed graph G comprising a set of node features {nᵢ}_{i=1 . . . N}_{ₙ} where Nₙ is the number of nodes and each nᵢ is a vector of node features; a set of directed edge features {eⱼ, sⱼ, rⱼ}_{j=1 . . . N}_{ₑ} where Nₑ is the number of edges and each eⱼ is a vector of edge features and sⱼ and rⱼ are the indices of the sender and receiver nodes respectively; and a vector of global features g. For the input graph the vector of node features may be derived from the node attributes, such as agent position and velocity; where attributes are not applicable e.g. the state of a non-agent entity, they may be given a zero value. For the input graph the edges may have no attributes, and the vector of global features may represent the global score or reward where applicable.

The graph neural network subsystem 110 processes an input graph G=(g, {nᵢ}, {eⱼ, sⱼ, rⱼ}) to determine an output graph G*=(g*, {n*ᵢ}, {e*ⱼ, sⱼ, rⱼ}). In general, though not necessarily, the input and output graphs may have different features.

The graph neural network subsystem 110 has three sub-functions, and edge-wise function ƒₑ, a node-wise function ƒₙ, and a global function ƒ_{g}. Each of these is implemented with a different respective neural network i.e. a neural network with different parameters (weights), i.e. an edge neural network, a node neural network, and a global feature network respectively. In variants some neural networks, and/or updates as described later, may be omitted.

In some implementations each of these functions is implemented with a respective multi-layer perceptron (MLP). In some implementations one or more of these functions may be implemented using a recurrent neural network. In this case (not shown) the function i.e. the recurrent neural network, takes an additional hidden graph Gₕ as an input and additionally provides an updated hidden graph G*ₕ as an output. The input and hidden graphs may be combined e.g. using a GRU (Gated Recurrent Unit) style or LSTM (Long Short-Term Memory) style gating scheme. The output may be split to obtain the updated hidden graph G*ₕ and an output graph e.g. by copying.

In implementations the graph neural network subsystem 110 is configured to process the input graph by first applying the edge-wise function ƒₑ to update all the edges (in each specified direction), then applying the node-wise function ƒₙ to update all the nodes, and finally applying the global function ƒ_{g} to update the global feature vector.

FIG. 2b illustrates operation of the example graph neural network subsystem 110. At step 200 the process, for each edge {eⱼ, sⱼ, rⱼ}, gathers the sender and receiver node features nₛ_{ⱼ}, nᵣ_{ⱼ}, as well as the edge feature vector and the global feature vector, and computes the output edge vectors, e*ⱼ=ƒₑ (g, nₛ_{ⱼ}, nᵣ_{ⱼ}, eⱼ) using the edge neural network. Then at step 202, for each node {nᵢ}, the process aggregates the edge vectors for that node as receiver using an aggregation function to determine a set of aggregated edge features êᵢ. The aggregation function should be invariant with respect to permutations of the edge vectors. For example it may comprise determination of a mean or maximum or minimum value. In some implementations the aggregation function may comprise elementwise summation e.g. êᵢ=Σⱼe*ⱼ for edges with rⱼ=i. Then the output node vector n*ᵢ is computed from the set of aggregated edge features, the current node feature vector, and the global feature vector, using the node neural network, n*ᵢ=ƒₙ(g, nᵢ,êᵢ). Finally, for each graph, the process aggregates all the edge and all the node feature vectors, step 204, e.g. by element wise summation: ê=Σⱼe*ⱼ, \hat{n}=Σᵢn*ᵢ, and the current global feature vector g, and computes the output global feature vector g* using the global feature neural network, g*=ƒ_{g}(g,\hat{n},ê).

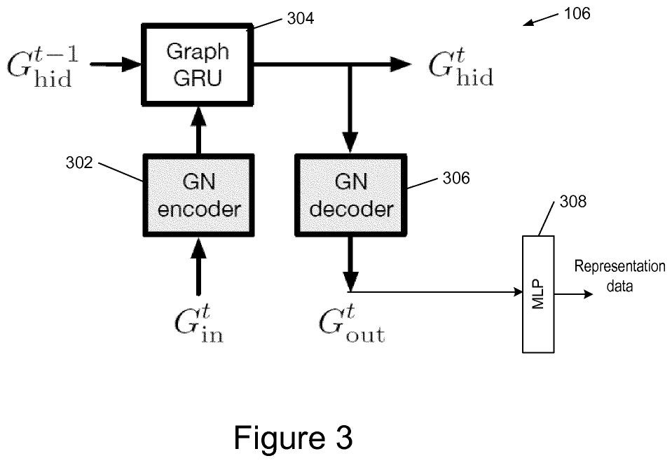

FIG. 3 shows an implementation of the graph processing neural network system 106. This comprises an encoder graph neural network subsystem (GN encoder) 302 coupled to a recurrent graph neural network subsystem (e.g. Graph GRU) 304 coupled to a decoder graph neural network subsystem (GN decoder) 306. Each graph neural network subsystem may be as described with reference to FIG. 2. The input graph Gᵢₙ^{t} at a time step t is processed by the GN encoder 302 to provide encoded graph data. The encoded graph data is processed by the recurrent graph neural network subsystem 304 in conjunction with a hidden graph for the previous time step G_{hid}^{t-1} to provide an updated hidden graph for the time step G_{hid}^{t} and processed graph data, which may be referred to as a latent graph. The latent graph is decoded by the GN decoder 306 to provide an output graph for the time step Gₒᵤₜ^{t}.

The representation data may be derived directly from one or more attributes of the output graph or the output graph may be further processed, e.g. by an MLP 308, to provide the representation data. For example the node attributes of each agent node of the output graph may be processed by the MLP 308, which may be a single layer “MLP”, to reduce the set of node attributes to a set of output values for predicting the action of the agent. The set of output values may comprise e.g. a set of logits for available actions of the agent or may define a distribution e.g. for continuous actions. In general the graph processing neural network system 106 may be applied to discrete or continuous actions.

The graph processing neural network system 106 may be trained by training the graph neural network subsystems jointly; they may be trained based on any of the output attributes. Supervised training is used based on datasets of input-output pairs, back-propagating the gradient of any suitable loss function and using backpropagation through time to train the recurrent graph neural network subsystem. For example in one implementation gradient descent is used to minimize a cross-entropy loss between predicted and ground-truth actions of the agents, in batches of e.g. 128 episodes.

The architecture of FIG. 3, which comprises three separate graph neural network subsystems, an encoder, a recurrent block, and a decoder, allows the system to perform relational reasoning on the raw input data before time recurrence is included, and then again on the output of the recurrent subsystem. This allows the recurrent graph neural network subsystem to construct memories of the relations between entities, rather than just of their current state.

In one example implementation the architecture of FIG. 3 is as follows: The graph encoder neural network subsystem 302 comprises a separate 64-unit MLP with one hidden layer and ReLU activations for each of the edge, node, and global neural networks; each of the edge, node, and global neural networks of the recurrent graph neural network subsystem 304 comprises a GRU with a hidden state size of 32; the decoder neural network subsystem 306 is the same as the encoder; the aggregation functions comprise summations.

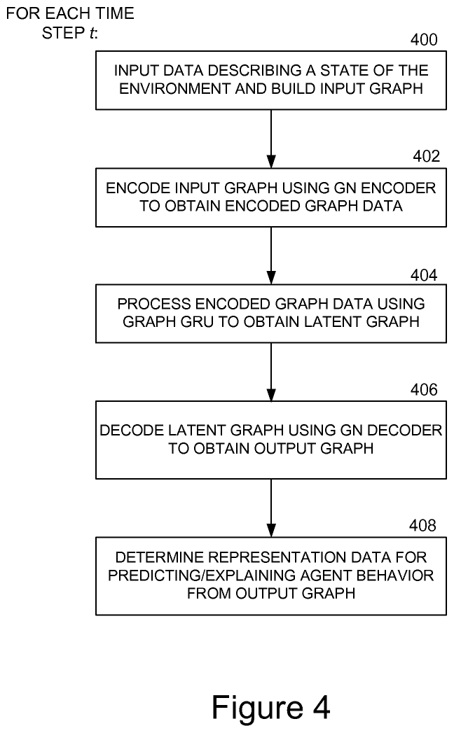

FIG. 4 shows a process for using the graph processing neural network system 106 to provide representation data predicting an agent action. For each time step t the process inputs data defining a (semantic) description of the state of the environment and builds the input graph using this data (400). The process then encodes the input graph using the GN encoder 302 to provide encoded graph data (402), processes the encoded graph data with the Graph GRU 304 to provide a latent graph (404), and decodes the latent graph using the GN decoder to provide the output graph (406). The process may then determine the representation data from the output graph e.g. by processing the output graph using MLP 308 and/or as described below, to predict or explain the actions of one or more of the agents (408).

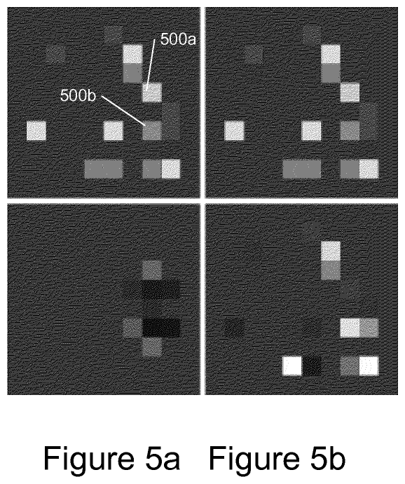

FIG. 5a (lower) shows an example representation, as a heat map, of action predictions from the graph processing neural network system 106. FIG. 5a (upper) shows locations of agents 500a,b on a x,y-position grid. In this example possible agent actions comprise the agent not moving and the agent moving to one of four adjacent positions on the grid (one of 5 actions). The lower figure shows, for each agent position, the probability of the agent moving to each of four adjacent positions on the grid and not moving. Each position is coded e.g. using a grayscale representation, with a prediction logit for the respective action.

FIG. 5b (lower) shows an example representation, as a heat map, of agent-entity importance relationships from the graph processing neural network system 106. These relationships are usable to explain agent behavior and may be derived from the edge attributes of the output graph. For example to determine the strength of relationships between a particular agent and other entities the Euclidean norm of each edge vector connecting the node for that agent with the nodes for each of the other entities may be determined. In FIG. 5b (lower) the location of each of the other entities is coded, e.g. using a grayscale, with the strength of the relationship between the particular agent 500a and the entity (FIG. 5b, upper, is the same as FIG. 5a, upper). Thus this representation may indicate how influential an entity is on the particular agent.

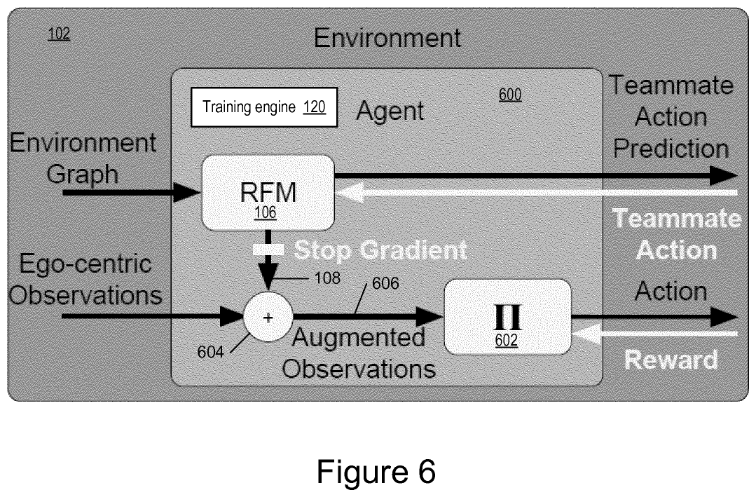

FIG. 6 shows an agent 600 which is one of the agents in the shared environment 102. For example the agent 600 may be a robot or vehicle in an environment with other robots or vehicles, and optionally non-agent entities. The agent incorporates the graph processing neural network system (Relational Forward Model, RFM) 106 of FIG. 3 into a reinforcement learning (RL) system, here represented as an action selection policy network (II) 602. Some, all or none of the other agents may include a similar RL system.

In the illustrated example the RFM 106 receives the semantic description of the state of the environment e.g. in the form of an environment graph, and also receives for one or more other agents, e.g. teammates, the last action taken by the agent. This information is compiled into an input graph (pre-processing is not shown). In other implementations the agent may infer some or all of this information from observations of the environment.

The agent also receives observations, e.g. egocentric observations of the environment for the reinforcement learning system. The observations may comprise still or moving images, and/or any form of sensor data, and/or any other data characterizing the current state of the environment. The RL system also receives reward data e.g. defining a numeric value, from the environment relating to rewards received by the agent for performing actions. The representation data output 108 from the RFM 106 is provided to the RL system, and may be combined with the observations of the environment by a combiner 604 to provide augmented observations 606.

The representation data may comprise a prediction of the actions of one or more of the other agents, for example in the form of a heat map as shown in FIG. 5a (lower). When both the observations and the heat map (or other representation) are represented egocentrically the action predictions may comprise an additional image plane attached to the observation. Each other agent may have a separate additional image plane, or the data in the image planes may be combined into a single additional image plane.

The representation data may also or instead comprise a representation of the salience of some or all of the other entities to actions of the agent (or to actions of other agents) for example in the form of a heat map as shown in FIG. 5b (lower). The other entities may be agents and/or non-agent entities. When both the observations and the heat map (or other representation) are represented egocentrically the influences of other entities on the agent, or of the other entities on other agents, may similarly comprise an additional image plane attached to the observation.

The reinforcement learning system processes the augmented observations and reward data and selects actions to be performed by the agent in order to perform a task. The task may be implicitly defined by the reward data. The actions may be selected from a discrete set of actions or may be continuous control actions; examples of tasks and actions are given later. In general actions are selected using the action selection policy network 602; this may output Q-values for selecting actions, or it may define a distribution for selecting actions, or may it directly output an action. The action selection policy network 602 may be trained using any appropriate reinforcement learning technique, for example, a Q-learning technique or an actor-critic technique.

In more detail, in one example, an action selection output of the action selection policy network 602 may include a respective numerical probability value for each action in a set of possible actions that can be performed by the agent. The RL system can select the action to be performed by the agent, e.g., by sampling an action in accordance with the probability values for the actions, or by selecting the action with the highest probability value.

In another example, the action selection output may directly define the action to be performed by the agent, e.g., by defining the values of torques that should be applied to the joints of a robotic agent or the values of accelerations to be applied to a robot or vehicle drive.

In another example, the action selection output may include a respective Q-value for each action in the set of possible actions that can be performed by the agent. The RL system can process the Q-values (e.g., using a soft-max function) to generate a respective probability value for each possible action, which can be used to select the action to be performed by the agent. The RL system may also select the action with the highest Q-value as the action to be performed by the agent. The Q value for an action is an estimate of a return that would result from the agent performing the action in response to the current observation and thereafter selecting future actions performed by the agent in accordance with the current values of the action selection policy network parameters. Here a return refers to a cumulative measure of reward received by the agent, for example, a time-discounted sum of rewards.

In some cases, the RL system can select the action to be performed by the agent in accordance with an exploration policy. For example, the exploration policy may be an ϵ-greedy exploration policy, where the RL system selects the action to be performed by the agent in accordance with the action selection output with probability 1−ϵ, and selects the action to be performed by the agent randomly with probability ϵ. In this example, ϵ is a scalar value between 0 and 1.

In implementations the training engine 120 may train both the RFM 106 and the RL system. They may be trained jointly, that is the agent 600 may have a private RFM 106 which is trained alongside the action selection policy network 602. The RFM 106 may be trained using supervised learning as previously described, with predicted-action observed-action pairs. As indicated in FIG. 6, in implementations gradients are not backpropagated through the RL system into the RFM 106.

In one implementation, the training engine 120 trains the action selection policy network 602 using an actor-critic technique. In this implementation, the action selection policy network 602 is configured to generate a value estimate in addition to an action selection output. The value estimate represents an estimate of a return e.g. a time-discounted return that would result, given the current state of the environment, from selecting future actions performed by the agent in accordance with the current values of the action selection network parameters. The training engine may train the action selection policy network using gradients of a reinforcement learning objective function [symbol] _{RL} given by:

[symbol]

_{RL}= [symbol] _{π}+α [symbol] _{V}+β [symbol] _{H}

[symbol]

_{π}=− [symbol] ₛ_{ₜ}_{˜π}[\hat{R}ₜ]

[symbol]

_{V}= [symbol] ₛ_{ₜ}_{˜π}[\hat{R}ₜ−V(sₜ,θ))²]

[symbol]

_{H}=− [symbol] ₛ_{ₜ}_{˜π}[H(π(⋅|sₜ,θ))]

where α and β are positive constant values, Eₛ_{ₜ}_{˜π}[⋅] refers to the expected value with respect to the current action selection policy (i.e., defined by the current values of the action selection policy network parameters θ), V (sₜ, θ) refers to the value estimate generated by the action selection policy network for observation sₜ, H(π(⋅|sₜ, θ)) is a regularization term that refers to the entropy of the probability distribution over possible actions generated by the action selection network for observation sₜ, and \hat{R}ₜ refers to the n-step look-ahead return, e.g., given by:

$${\hat{R}}_{t} = {\sum }_{i = 1}^{n - 1} {γ}^{i} {r}_{t + i} + {γ}^{n} V ( {s}_{t + n} , θ )$$

where γ is a discount factor between 0 and 1, rₜ₊₁ is the reward received at time step t+i, and V(sₜ₊ₙ, θ) refers to the value estimate at time step t+n.

In general entities in the environment may be natural or man-made and the environment may be a real-world environment or a simulated real-world environment, or a virtual environment. Agents may comprise computer-controlled or human-controlled machines such robots or autonomous land, sea, or air vehicles. Agents may also comprise humans and/or animals. Agents may further comprise static or mobile software agents i.e. computer programs configured to operate autonomously and/or with other software agents or people to perform a task such as configuration or maintenance of a computer or communications network or configuration or maintenance of a manufacturing plant or data center/server farm.

For example some implementations of the system may be used for prediction or control or vehicular or pedestrian traffic e.g. for traffic signal control to reduce congestion, or for prediction or control of teams of people performing a task or playing a game e.g by providing signals to the people based on an output e.g. representation data from the system. In some other implementations the system may be used for cooperative control of robots performing a task such as warehouse or logistics automation, package delivery control e.g. using robots, drone fleet control and so forth.

Any autonomous or semi-autonomous agent of the type previously described may include a reinforcement learning system to operate in conjunction with the RFM system to control the agent. Multiple autonomous or semi-autonomous agents of the type as described previously may include an RFM system and a control system e.g. a reinforcement learning system to operate in conjunction with the RFM system to facilitate cooperative behavior in complex environments.

In some implementations the agents may be of different types. For example in a warehouse setting autonomous vehicles or warehouse control robots from more than one different manufacturer may be operating. In such a case equipping each of these robots/vehicles with a combination of a reinforcement learning system and the RFM system allows the different entities to learn to work together. Similar benefits can be obtained with other types of agents.

Non-agent entities may comprise any non-agent objects in the environments of the above-described agents.

In some still further applications for an agent of the type shown in FIG. 6, in which the Relational Forward Model is combined into a reinforcement learning system, the environment is a real-world environment and the agent is an electromechanical agent interacting with the real-world environment. For example, the agent may be a robot or other static or moving machine interacting with the environment to accomplish a specific task, e.g., to locate an object of interest in the environment or to move an object of interest to a specified location in the environment or to navigate to a specified destination in the environment; or the agent may be an autonomous or semi-autonomous land or air or sea vehicle navigating through the environment.

In these implementations, the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or e.g. motor control data. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g braking and/or acceleration of the vehicle.

For example the simulated environment may be a simulation of a robot or vehicle agent and the reinforcement learning system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle. A simulated environment can be useful for training a reinforcement learning system before using the system in the real world. In another example, the simulated environment may be a video game and the agent may be a simulated user playing the video game. Generally in the case of a simulated environment the observations may include simulated versions of one or more of the previously described observations or types of observations and the actions may include simulated versions of one or more of the previously described actions or types of actions.

In the case of an electronic agent the observations may include data from one or more sensors monitoring part of a plant or service facility such as current, voltage, power, temperature and other sensors and/or electronic signals representing the functioning of electronic and/or mechanical items of equipment. In some applications the agent may control actions in a real-world environment including items of equipment, for example in a facility such as: a data center, server farm, or grid mains power or water distribution system, or in a manufacturing plant or service facility. The observations may then relate to operation of the plant or facility. For example additionally or alternatively to those described previously they may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. For example the agent may control electrical or other power consumption, or water use, in the facility and/or a temperature of the facility and/or items within the facility. The actions may include actions controlling or imposing operating conditions on items of equipment of the plant/facility, and/or actions that result in changes to settings in the operation of the plant/facility e.g. to adjust or turn on/off components of the plant/facility.

In some further applications, the environment is a real-world environment and the agent manages distribution of tasks across computing resources e.g. on a mobile device and/or in a data center. In these implementations, the actions may include assigning tasks to particular computing resources.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A neural network system for predicting or explaining the actions of multiple agents in a shared environment, the neural network system comprising:
one or more computers and one or more storage devices storing instructions that when executed by the one or more computers cause the one or more computers to implement:
an encoder graph neural network subsystem to process the agent data as graph data to provide encoded graph data,
wherein the agent data represents agent actions for each of multiple agents;
wherein the graph data comprises (i) data representing at least nodes and edges of a graph and (ii) node attributes for at least some of the nodes in the graph,
wherein the nodes represent the agents and one or more non-agent entities in the environment,
wherein the edges connect nodes in the graph,
wherein the node attributes represent the agent actions of the agents, and
wherein the encoded graph data comprises node attributes and edge attributes representing an updated version of the graph data;
a recurrent graph neural network subsystem comprising a recurrent neural network to process the encoded graph data and provide processed graph data comprising an updated version of the node attributes and edge attributes of the encoded graph data;
a decoder graph neural network subsystem to decode the processed graph data and provide decoded graph data comprising an updated version of the node attributes and edge attributes of the processed graph data; and
a system output to provide representation data comprising a representation of one or both of the node attributes and edge attributes of the decoded graph data for one or more of the agents, wherein the representation relates to a predicted or explained action of one or more of the agents.

2. A neural network system as claimed in claim 1 wherein the agent data representing agent actions comprises agent position and motion data for each of multiple agents, and wherein the node attributes for determining the actions of each agent further include attributes for the position and motion of each agent.

3. A neural network system as claimed in claim 1 wherein each of the agents is connected to each of the other agents by an edge and wherein each of the non-agent entities is connected to each of the agents by an edge.

4. A neural network system as claimed in claim 1 wherein the system output comprises one or more output neural network layers to combine the node attributes for a node in the decoded graph data to output the representation data, and wherein the representation comprises a predicted action of the agent represented by the node.

5. A neural network system as claimed in claim 4 wherein the representation data defines a spatial map of data derived from the node attributes of one or more nodes representing one or more of the agents and wherein, in the spatial map, the data derived from the node attributes is represented at or adjacent a position of the respective node.[p9 note 2][action scores/logits]

6. A neural network system as claimed in claim 1 wherein the representation data comprises a representation of the edge attributes of the decoded graph data for the edges connecting to one or more of the nodes, and wherein the representation of the edge attributes for an edge is determined from a combination of the edge attributes for the edge.

7. A neural network system as claimed in claim 6 wherein the representation data defines a spatial map and wherein, in the spatial map, the representation of the edge attributes for an edge is represented at an origin node position for the edge.

8. A neural network system as claimed in claim 1 wherein one or more of the encoder, processing, and decoder graph neural network subsystems is configured to:
for each of the edges, process the edge features using an edge neural network to determine output edge features,
for each of the nodes, aggregate the output edge features for edges connecting to the node to determine aggregated edge features for the node, and
for each of the nodes, process the aggregated edge features and the node features using a node neural network to determine output node features.

9. A neural network system as claimed in claim 8 wherein processing the edge features comprises, for each edge, providing the edge features and node features for the nodes connected by the edge to the edge neural network to determine the output edge features.

10. A neural network system as claimed in claim 8 wherein one or more of the encoder, processing, and decoder graph neural network subsystems is further configured to determine a global feature vector using a global feature neural network, the global feature vector representing the output edge features and the output node features, and wherein a subsequent graph neural network subsystem is configured to process the global feature vector when determining the output edge features and output node features.

11-15. (canceled)

16. A method of predicting or explaining the actions of multiple agents in a shared environment, the method comprising:
receiving agent data representing actions for each of multiple agents;
processing the agent data as graph data to provide encoded graph data,
wherein the graph data comprises data representing at least nodes and edges of a graph, wherein each of the agents is represented by a node, wherein non-agent entities in the environment are each represented by a node, wherein the nodes have node attributes for determining the actions of each agent, wherein the edges connect the agents to each other and to the non-agent entities, and wherein the encoded graph data comprises node attributes and edge attributes representing an updated version of the graph data;
processing the encoded graph data using a recurrent graph neural network to provide processed graph data comprising an updated version of the node attributes and edge attributes of the encoded graph data;
decoding the processed graph data to provide decoded graph data comprising an updated version of the node attributes and edge attributes of the processed graph data; and
outputting a representation of one or both of the node attributes and edge attributes of the decoded graph data for one or more of the agents, wherein the representation relates to a predicted or explained behaviour of the agent.

17. A method as claimed in claim 16 wherein the behaviours comprise actions of the agents, and wherein outputting the representation comprises processing the node attributes for a node of the decoded graph data to determine a predicted action of the agent represented by the node.

18. A method as claimed in claim 16 for explaining the actions of the agents, wherein outputting the representation comprises processing the edge attributes of an edge of the decoded graph data connecting an influencing node to an agent node to determine data representing the importance of the influencing node to the agent node.

19. (canceled)

20. One or more non-transitory computer-readable storage media storing instructions that when executed by one or more computers cause the one or more computers to implement a system comprising:
an encoder graph neural network subsystem to process the agent data as graph data to provide encoded graph data,
wherein the agent data represents agent actions for each of multiple agents;
wherein the graph data comprises (i) data representing at least nodes and edges of a graph and (ii) node attributes for at least some of the nodes in the graph,
wherein the nodes represent the agents and one or more non-agent entities in the environment,
wherein the edges connect nodes in the graph,
wherein the node attributes represent the agent actions of the agents, and
wherein the encoded graph data comprises node attributes and edge attributes representing an updated version of the graph data;
a recurrent graph neural network subsystem comprising a recurrent neural network to process the encoded graph data and provide processed graph data comprising an updated version of the node attributes and edge attributes of the encoded graph data;
a decoder graph neural network subsystem to decode the processed graph data and provide decoded graph data comprising an updated version of the node attributes and edge attributes of the processed graph data; and
a system output to provide representation data comprising a representation of one or both of the node attributes and edge attributes of the decoded graph data for one or more of the agents, wherein the representation relates to a predicted or explained action of one or more of the agents.

21. One or more non-transitory computer-readable storage media as claimed in claim 20 wherein the agent data representing agent actions comprises agent position and motion data for each of multiple agents, and wherein the node attributes for determining the actions of each agent further include attributes for the position and motion of each agent.

22. One or more non-transitory computer-readable storage media as claimed in claim 20 wherein each of the agents is connected to each of the other agents by an edge and wherein each of the non-agent entities is connected to each of the agents by an edge.

23. One or more non-transitory computer-readable storage media as claimed in claim 20 wherein the system output comprises one or more output neural network layers to combine the node attributes for a node in the decoded graph data to output the representation data, and wherein the representation comprises a predicted action of the agent represented by the node.

24. One or more non-transitory computer-readable storage media as claimed in claim 23 wherein the representation data defines a spatial map of data derived from the node attributes of one or more nodes representing one or more of the agents and wherein, in the spatial map, the data derived from the node attributes is represented at or adjacent a position of the respective node.

25. One or more non-transitory computer-readable storage media as claimed in claim 20 wherein the representation data comprises a representation of the edge attributes of the decoded graph data for the edges connecting to one or more of the nodes, and wherein the representation of the edge attributes for an edge is determined from a combination of the edge attributes for the edge.

26. One or more non-transitory computer-readable storage media as claimed in claim 25 wherein the representation data defines a spatial map and wherein, in the spatial map, the representation of the edge attributes for an edge is represented at an origin node position for the edge.
